(19) United States
(12) Patent Application Publication
(10) Pub. No.: US 2025/0291609 A1
(43) Pub. Date: Sep. 18, 2025

(54) Automated User Interface Customization

(71) Applicant: Cerner Innovation, Inc., Kansas City, MO (US)

(72) Inventors: Praveen Bhat GURPUR, Bengaluru (IN); Indra Raj ANAND, Uttar Pradesh (IN)

(21) Appl. No.: 18/781,190

(22) Filed: Jul. 23, 2024

Related U.S. Application Data
(60) Provisional application No. 63/566,459, filed on Mar. 18, 2024.

(51) Int. Cl. G06F 9/451

(52) U.S. Cl. CPC G06F 9/451

(57) ABSTRACT

Embodiments optimize a user interface (“UI”) of an application for a user. Embodiments train a machine learning (“ML”) model on one or more optimized routes for navigating the UI to arrive at a desired result. Embodiments monitor at least a portion of a first navigation route during a user interaction with the UI to achieve the desired result. Embodiments determine by the ML model that the first navigation route is not the one or more optimized routes and redirect the user to one of the optimized routes during the user interaction.

### CROSS REFERENCE TO RELATED APPLICATIONS

This application claims priority of U.S. Provisional Patent Application Ser. No. 63/566,459, filed on Mar. 18, 2024, the disclosure of which is hereby incorporated by reference.

### FIELD

One embodiment is directed generally to a computer system, and in particular to the user interface of a computer system.

### BACKGROUND INFORMATION

Automated user interface (“UI”) customization is essential for several reasons, driven by the diverse needs and preferences of users in today's digital landscape. Specifically, users come from various backgrounds, age groups and levels of technological proficiency. Automated customization allows for tailoring interfaces to meet the specific needs and preferences of different user segments, enhancing user experience and accessibility.

Further, UI customization is crucial for ensuring accessibility for individuals with different abilities and disabilities. Automated UI customization enables features such as text size adjustment, color contrast modification and screen reader compatibility, making digital interfaces more inclusive. Further, users appreciate personalized experiences that cater to their preferences. Automated UI customization allows systems to learn from user behavior and adjust the interface accordingly. This personalization enhances user engagement, satisfaction and overall usability.

Further, users access applications and websites on a wide range of devices and platforms, including desktops, laptops, tablets, and smartphones. Automated customization ensures that the UI adapts seamlessly to different screen sizes and resolutions, optimizing the user experience across various devices. Further, users from different cultures and regions may have distinct preferences regarding language, layout, and content presentation. Automated customization can take these factors into account, providing a more culturally sensitive and relevant user interface.

With the continuous evolution of technology, user expectations are constantly changing. Automated UI customization allows developers to adapt interfaces quickly to meet new trends and expectations without requiring manual redesigns for each change. Customizing the user interface based on user preferences can improve efficiency and productivity. Users can arrange and prioritize features according to their workflow, reducing the time and effort required to perform tasks.

Further, automated customization enables adaptive design that can respond to changing contexts and user needs. For example, a mobile app may adjust its interface based on whether the user is walking or sitting, providing a more context-aware and user-friendly experience. Finally, offering a highly customizable and user-friendly interface can be a competitive advantage. Users are more likely to choose and remain loyal to products or services that provide a tailored and enjoyable experience.

### SUMMARY

Embodiments optimize a user interface (“UI”) of an application for a user. Embodiments train a machine learning (“ML”) model on one or more optimized routes for navigating the UI to arrive at a desired result. Embodiments monitor at least a portion of a first navigation route during a user interaction with the UI to achieve the desired result. Embodiments determine by the ML model that the first navigation route is not the one or more optimized routes and redirect the user to one of the optimized routes during the user interaction.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Further, elements may not be drawn to scale.

FIG. 1 illustrates an example of a system that includes a UI customizer system in accordance to embodiments.

FIG. 2 is a block diagram of the UI customizer system of FIG. 1 in the form of a computer server/system in accordance to an embodiment of the present invention.

FIG. 3 is a flow/block diagram of the functionality of the UI customizer of FIG. 1 when performing automated UI customization in accordance to embodiments.

FIG. 4 illustrates monitoring sequence of steps undertaken by a user of an application in accordance to embodiments.

FIG. 5 illustrates redirecting the sequence of steps undertaken by a user of an application in accordance to embodiments.

FIG. 6 is an example of automatically changing contrast in accordance to embodiment.

FIG. 7 illustrates automatically generated suggestions in accordance to embodiments.

FIG. 8 illustrates automatically generated error messages in accordance to embodiments.

FIGS. 9-12 illustrate an example cloud infrastructure that can implement the system that can include the UI customizer system of FIG. 1 in accordance to embodiments.

### DETAILED DESCRIPTION

One embodiment is a cloud based tool that automatically adjusts user interface (“UI”) components of any software/interface/application to enhance usability based on cues obtained from user behavior/activity while interacting with the UI using a trained machine learning (“ML”) model. Embodiments can customize the UI and also determine if the current activity of the user is optimal for the UI, and if not, provide suggestions in order to optimize the activity. As a result, embodiments enable the UI of any application to be changed without manual intervention from the user, thus delivering a seamless experience without the user actually knowing the UI is changing as per their need. The user simply experiences what is the most optimal, customized/tailored version of the UI.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

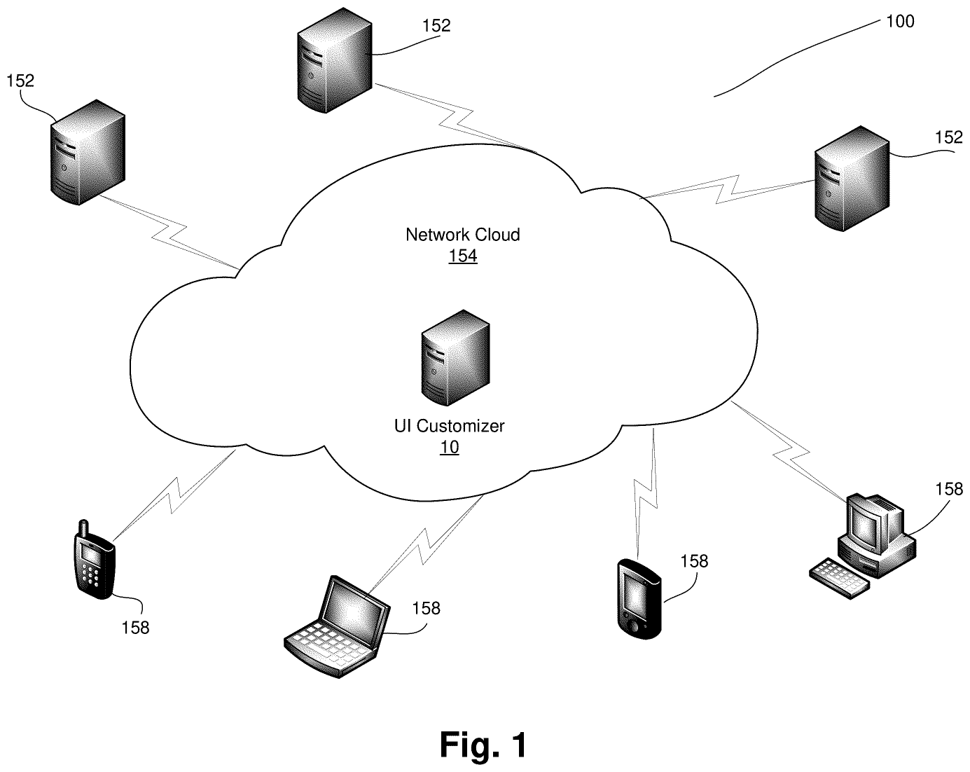

FIG. 1 illustrates an example of a system 100 that includes a UI customizer system 10 in accordance to embodiments. UI customizer system 10 may be implemented within a computing environment that includes a communication network/cloud 154. Network 154 may be a private network that can communicate with a public network (e.g., the Internet) to access additional services 152 provided by a cloud services provider. Examples of communication networks include a mobile network, a wireless network, a cellular network, a local area network (“LAN”), a wide area network (“WAN”), other wireless communication networks, or combinations of these and other networks. UI customizer system 10 may be administered by a service provider, such as via the Oracle Cloud Infrastructure (“OCI”) from Oracle Corp.

Tenants of the cloud services provider can be companies or any type of organization or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 158, which can be any type of device that can access network 154 and can obtain the benefits of the functionality of UI customizer system 10 of customizing the UI for any application. As disclosed herein, a “client” (also disclosed as a “client system” or a “client device”) may be a device or an application executing on a device. System 100 includes a number of different types of client devices 158 that each is able to communicate with network 154.

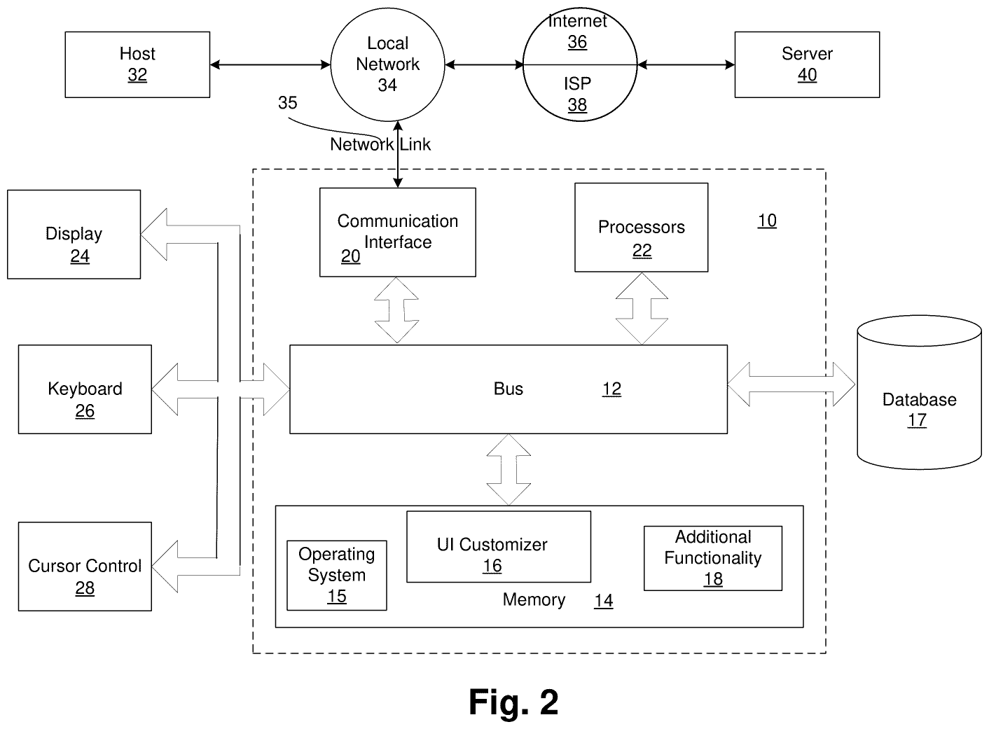

FIG. 2 is a block diagram of UI customizer system 10 of FIG. 1 in the form of a computer server/system 10 in accordance to an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a UI customizer module 16 that automatically customizes UIs using AI, and all other functionality disclosed herein. System 10 can be part of a larger system. Therefore, system 10 can include one or more additional functional modules 18, such as any application that utilizes a UI that can be customized using the functionality of UI customizer module 16. A file storage device or database 17 is coupled to bus 12 to provide centralized storage for modules 16 and 18, including training data used to generate a machine learning (“ML”) model implemented by UI customizer module 16. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 10, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

As disclosed, for software applications with a user-facing front-end, it is important to have a UI that is user-friendly. This directly impacts the usage of applications. Since acceptance or rejection by end-user has a direct bearing on its success, it is important to design the UI with the convenience of the end-user in mind. This is challenging because the exact profile of the potential end-user is difficult to determine, and therefore UI designers may take a middle path in UI design. However, this approach of “one size fits all” may not work, giving rise to UI challenges, and in a worse case scenario, complete rejection of the application by intended users in the market.

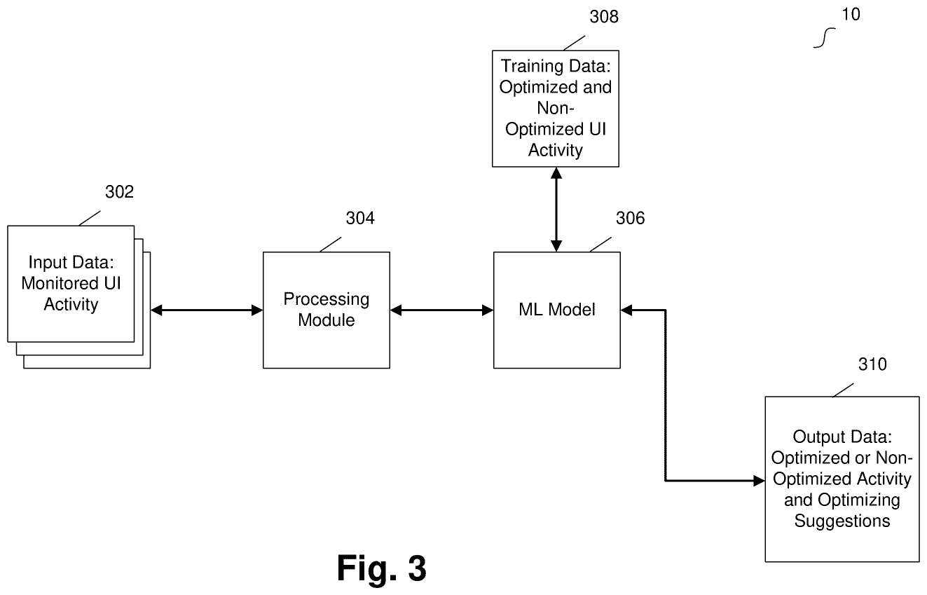

FIG. 3 is a flow/block diagram of the functionality of UI customizer 10 of FIG. 1 when performing automated UI customization in accordance to embodiments. In one embodiment, the functionality of the flow/block diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

System 10 includes input data 302, a processing model 304, an ML model 306, training data 308, and output data 310. Training data 308 is historical activity by one or more users of a UI of an application, such as navigating between items on the UI. In embodiments, the functionality of system 10 is relevant to one application, and one UI for the application. However, the functionality of system 10 can be duplicated for multiple applications and multiple UIs. Training data 308 may be labeled data, so that, for example, certain historical navigation is labeled as either “optimal” navigation, or “non-optimal” navigation. Processing module 304 can be used to process input data 302 (i.e., live UI navigation data).

Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. ML model 306 can be any type of machine learning model (e.g., neural network, support vector machine (“SVM”), random forests, gradient boosting, large language model (“LLM”) etc.) that is trained by training data 308. ML model 306 is a combination of hardware/software that learns patterns from data (i.e., training data 308) in order to make predictions or decisions without being explicitly programmed to perform the task. ML model 306 is configured to generalize from the provided examples and improve its performance over time as they are exposed to more data.

ML model 306 may learn from labeled examples (i.e., supervised learning) or find patterns in data (i.e., unsupervised learning) to make predictions or uncover hidden structures. ML model 306 can be trained using algorithms that adjust model parameters to minimize the difference between predicted outputs and actual outputs, or to maximize some objective function in unsupervised learning. ML model 306 may not only fit training data 308 well but also generalizes to new, unseen test data accurately.

As an example, in one embodiment, ML model 306 is trained to determine the most optimal sequence of steps on a UI to achieve the result. This is based on running multiple training sets where the least number of steps and least amount of time taken to achieve the result/accomplishing the task are the criteria used to determine optimal sequences.

ML model 306 generates output data 310, such as a prediction of whether a sequence of navigation is optimal, or aids (e.g., arrows) to assist navigation, in response to input data 302. Prediction model 306 may also generate suggestions for turning non-optimized navigation into optimized navigation. Input data 302, in embodiments, is “live” navigation data that is similar to training data 308. Embodiments monitor specific parameters, disclosed below that form input data 302 in the background when the user opens the application of interest.

In one embodiment, the monitored input data 302 includes the time taken between successive clicks. For example, if the user is taking an unusually long time between successive clicks, the reasons can include that they are unsure where to go next, do not know the next step, feel a lack of direction navigating through the software, etc. Embodiments can determine an average amount of time over multiple clicks, and determine if it exceeds a predefined value. In response, embodiments automatically provide suggestions, determined by model 306, to the user via a popup window or other mechanism. The suggestions can explain/elucidate what is being asked in the current component/item that user is working on, or suggest/prompt information that needs to be entered into the particular item in order to proceed to the next step.

In one embodiment, the monitored input data 302 includes the path of navigation between items followed by the user to determine whether a longer path of navigation (as opposed to an optimized path) between items is being taken by the user. For example, if the user is following a route when navigating through the items that has lesser chances of reaching the end-goal, the reason could be that the items displayed in the software need to be rearranged, or visually changed to make them more intuitive to the user as to which route to take. In response, embodiments automatically change the order of the items, placing appropriate items one after another in an order that suits the responses of the user thus far, and anticipating the next steps in the navigation. This makes it convenient for the user to simply go to the next item intuitively.

In one embodiment, the monitored input data 302 includes the number of times a user tries different navigation routes before arriving at their desired result. For example, the user may try multiple clicks in succession, then backtrack and try a different sequence of clicks-they could repeat this until they reach the end of the task that they set out for. This indicates that the user is not able to understand the sequence of clicks that they need to perform as they navigate through the software.

In response to a higher number of times the user tries different routes before arriving at their desired result, embodiments can provide indicators, such as arrows, on the UI. These arrows guide the user on which item they should next click, so as to minimize the path and time spent. ML model 306 ensures that based on the user's answer/choice in the current item, the arrows may point to different items that can be user specific.

In one embodiment, the monitored input data includes the time taken to reach the desired result/goal/task completion. For example, if the user takes a period of time longer than what is generally taken (e.g., average time taken by users) to reach a certain end-point in the application, this could indicate some difficulty experienced by the user during usage of the application. The exact steps at which the user spends more time is also determined by embodiments.

One of the reasons the user takes a longer time to reach the final step in the software could be that many items in the software could be irrelevant and need to be skipped to go to the relevant items for the particular user. This means the user has to tediously go through each item, decide if it is relevant/irrelevant for them, and then work on the item/skip the item as appropriate. Therefore, in response, embodiments can change the UI of the software by hiding those items that are irrelevant for the current user. For examples, if the user has indicated their gender as female in a health screening application, then embodiments hide items that are irrelevant for females such as questions on prostate health. Further, if the user has indicated their age as 76 years, embodiments can automatically adjust the font size of software to a larger size, to help easy visualization.

In one embodiment, the monitored input data includes the number of times the user switches between the particular software application and other applications. For example, if the user switches often between the software in question and other applications as they progress to successive steps, it is possible that they perceive the current application to be tedious and are doing other tasks in parallel or receiving help from external sources in understanding some aspects of the application in question.

In embodiments, when frequent switching between applications is detected, the following actions are taken:
A. Embodiments display a popup asking of the user if they wish to skip the non-mandatory sections and want to see only the mandatory sections. If the user answers affirmatively, then all optional sections are hidden and only the mandatory sections are shown
B. Next, embodiments help the user by pre-emptively displaying meanings/definitions of technical/difficult terminology whenever the user comes across them. Embodiments know the terminology the user faced difficulty with, based on their usage of the “Help” section of the software for looking up specific terminology.
C. In instances of applications targeted for specific age-groups, such as young users or senior citizens, embodiments keep the users engaged with periodic displays of age-specific interesting trivia or questionnaires, quizzes, etc.

In one embodiment, the monitored input data 302 includes the quantity of time spent and frequency of using the “Help” module of the software. For example, if the user uses the “Help” section of the software more than the average user, it is possible that they find navigating through the application difficult and need constant help in understanding usage of application.

In response to monitoring the quantity of time spent and frequency of using the “Help” module of the software, embodiments help the user by preemptively displaying meanings/definitions of technical/difficult terminology whenever the user comes across them. Embodiments know the terminology the user faced difficulty with, based on their usage of the “Help” section of the software for looking up specific terminology.

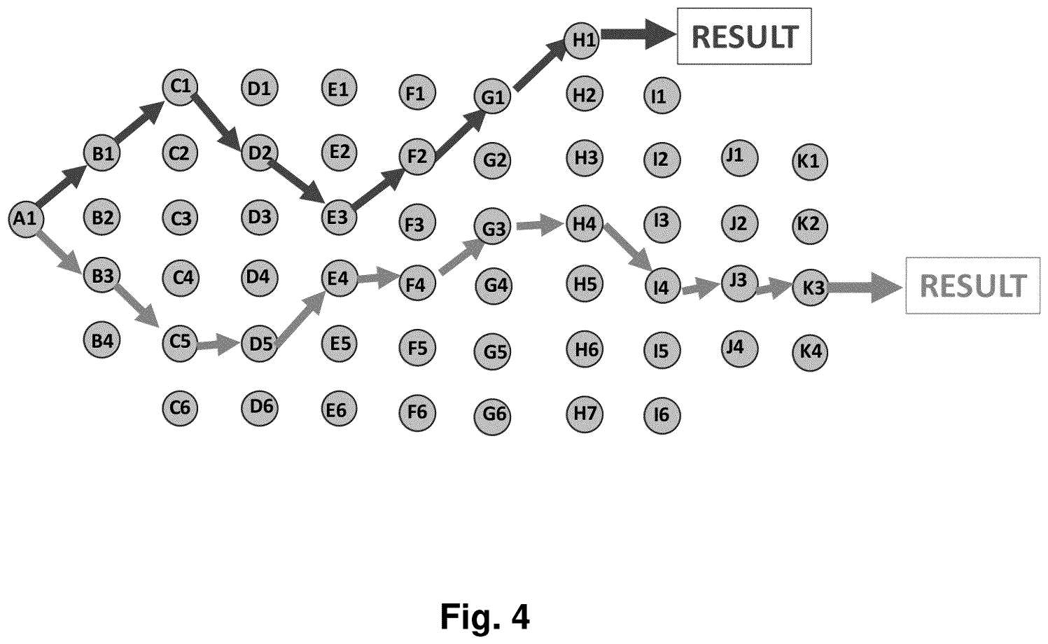

FIG. 4 illustrates monitoring sequence of steps undertaken by a user of an application in accordance to embodiments. As disclosed, in one embodiment, the sequence of steps taken by the user are monitored. Embodiments know/determine the most optimal path to be taken to reach the results in the shortest amount of time/least number of steps. Therefore, the most optimal next step will depend on what was chosen in the previous step. When embodiments sense that the user is not taking the optimal path, it helps the user by generating an indicator such as an arrow that points the user to the correct step.

For example, two optimal paths are shown in FIG. 4. Each step (e.g., “A1”, “B1”, etc.) represents a possible next selection of an option/component/window, etc., of the application. Starting at step A1, depending on the option chosen by the user, the ideal paths as determined by embodiments are either A1->B1->C1->D2->E3 . . . , etc., or A1->B3->C5->D5->E4 . . . , etc.

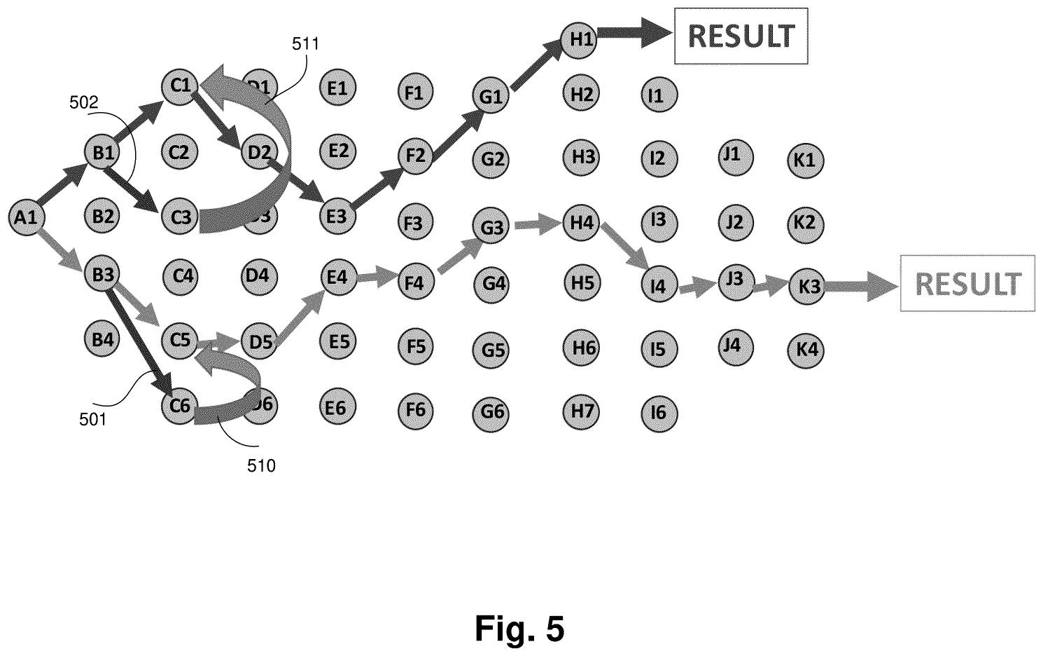

If, for example, the user goes to C6 from B3, embodiments detect this and help redirect the user to C5 using an indicator such as an arrow. FIG. 5 illustrates redirecting the sequence of steps undertaken by a user of an application in accordance to embodiments. As shown, arrows 501, 502 point to non-optimal steps taken by user, and arrows 510, 511, generated by embodiments, guide the user to the next optimal step to be taken.

As disclosed, ML model 306 is trained, using training data 308, to determine the most optimal sequence of steps to achieve the desired result. This is based on running multiple training sets where the least number of steps and least amount of time taken to achieve the result/accomplishing the task are the criteria used to determine optimal sequences.

Embodiments are also trained on training data 308 in order to customize the UI/application as per certain demographic parameters of the user, such as age, gender etc. For example, if the user is a younger person, certain aspects of the software may be brought earlier in the sequence of workflow, and certain aspects which are relevant for older age groups may be pushed to later in the sequence.

Embodiments are also trained to learn new sequences based on certain users who prefer the non-optimal route because they either want to explore the options available or may be searching for non-standard results. In such cases, embodiments note these variations and may suggest them as alternatives when the user chooses to ignore the prompting arrows and continues with their own sequence of steps.

When the user begins using the software, embodiments may ask them basic questions to understand their goal/task and make changes in the UI to help the user achieve their task in the most optimal way.

As an example of the above, when the user opens drawing software, embodiments may ask a simple question such as “What would you like to draw today?” The user replies “I want to draw a circle on a stick, like a lollipop. The circle needs to be red in color.” Embodiments immediately rearrange the ribbon feature at the top of the screen to bring in the option of a LINE and CIRCLE under the INSERT button, while it pushes all other shapes behind. In the color palette, it places RED COLOR in the first position, and the other colors following it.

Therefore, embodiments enable the user to quickly select the LINE and CIRCLE to make the figure of a lollipop, followed by choosing the RED COLOR to paint the circle, therefore saving time for the user. In case the user goes astray in searching for the color palette, after drawing the circle and stick, embodiments generate helpful indicators such as arrows to guide the user in reaching the color palette.

The above is an example of how UI is customized for each user, based on the task/goal. In instances the software is more complex and/or the user has not specified the task/goal beforehand, then embodiments can analyze cues from the user and make changes accordingly.

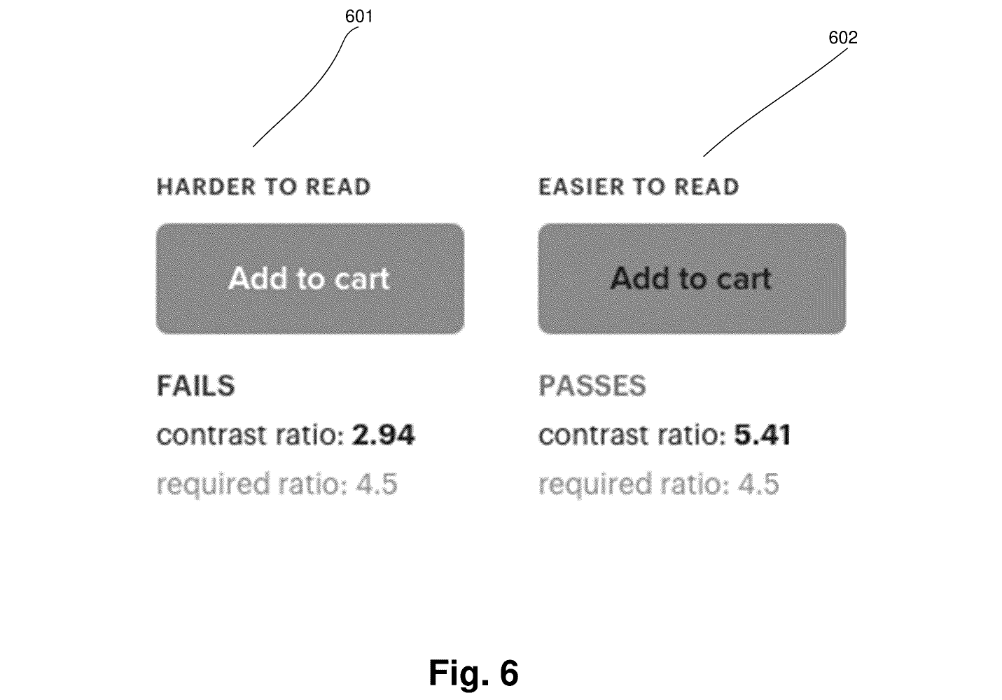

One embodiment automatically adjust the color contrast of the UI. In some instances, Sometimes, users may face difficulty in deciphering text or images displayed on the screen due to improper color contrast. In embodiments, when system 10 senses that the speed of usage of the user has slowed down in regions where color is used, it automatically adjusts the contrast for better visual clarity. FIG. 6 is an example of automatically changing contrast in accordance to embodiments. At 601, the color contrast ratio of 2.94 is considered failing, so at 602 the color contrast is automatically adjusted to 5.41.

One embodiment automatically provides keyboard navigation support. In certain types of software, keyboard shortcuts are often recommended to reduce time, number of clicks and effort for users. However, not all users are aware of the proper keyboard shortcuts to use. In embodiments, if system 10 detects that the user resorts to multiple mouse-clicks to achieve an objective instead of using keyboard shortcuts, it helps by automatically providing prompts that suggest the shortcuts to be used.

One embodiment automatically provides screen reader compatibility. For example, in a hospital or clinic environment, especially in departments of ophthalmology (i.e., eye diseases), system 10 can help by understanding the needs of users who have undergone recent eye procedures or are suffering from eye-ailments that reduce their visual acuity/power. For example, if system 10 knows from the electronic medical record (“EMR”) database that a user has high myopia (i.e., an eye ailment that reduces eye power), it can automatically increase font size of the text, so that the user can read with less eye-strain.

One embodiment auto-adjustments the UI as per the location, language and cultural norms of user. In embodiments, system 10 senses where the software is being used (e.g., from the GPS), and automatically adjusts the software UI. For example, if the user is in Japan, then system 10 automatically makes the software display its helpful hints in the Japanese language. If the user is in India, the date-display is automatically adjusted to DD-MM-YYYY format, and the English language display changes to the UK English. Greetings such as “Good morning”, etc., can be displayed in the local language as per the user's location. Embodiments automatically switch between gallons/ounces/miles, for users in the U.S., to liters/kilometers, for users in other parts of the world. Embodiments automatically adjust weekend holidays in the software from Sat-Sun to Fri-Sat, for users in middle east, etc.

One embodiment automatically provides contextual guidance and informative hints. In software involving filling forms, in one embodiment system 10 anticipates that users may get confused in certain parts of the form, and provides helpful suggestions to users, based on what they have filled in the form so far. For example, if the form is related to tax-filing, if system 10 detects that user has ticked “Non-resident alien” in line 4, it automatically suggests the user to skip lines 5-12 since they pertain to “Resident aliens and citizens”, and go directly to line 13. This saves time and effort for the user. If user has selected a certain income bracket but mistakenly selects a wrong tax bracket, then system 10 may suggest to user to re-check their selection.

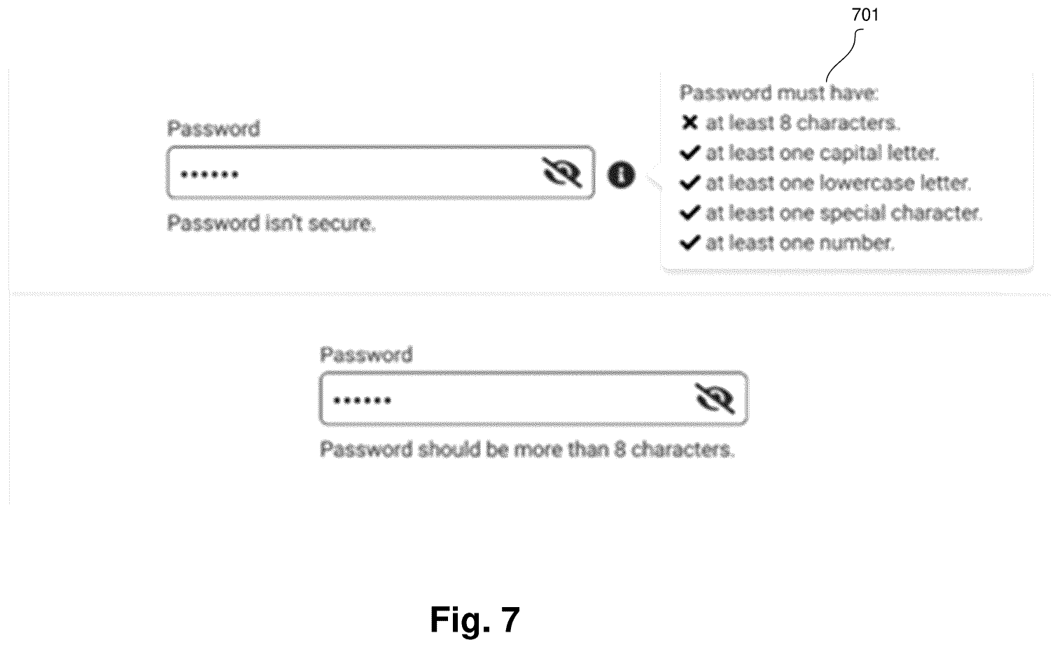

As another example, when a user is asked to choose a new password, system 10 can help them choose a secure password by indicating what is wrong with their current selection of a password. FIG. 7 illustrates automatically generated suggestions 701 in accordance to embodiments. The suggestions 701 are specific to what is actually wrong with the current selection instead of a generic list of password requirements.

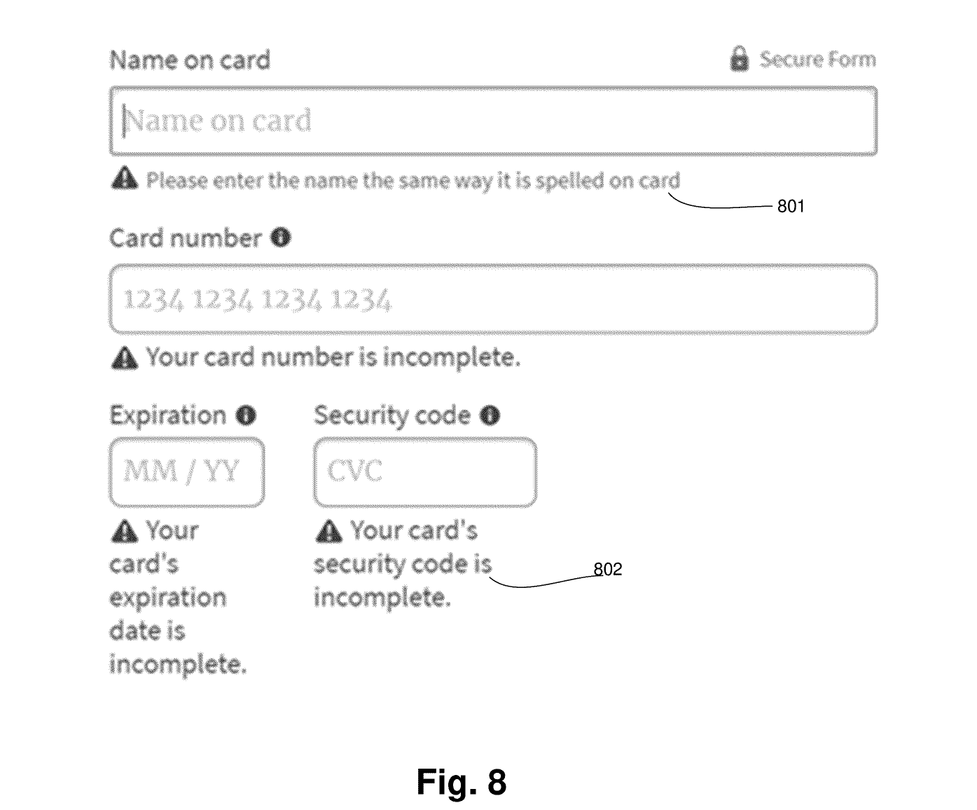

One embodiments automatically provides helpful error messages. Typically, error messages seen when using software are cryptic and not understandable by ordinary people who do not know computer jargon. For example, one commonly displayed error message is “Error 404”. However, because the user may not know what the error message means, and hence the remedy, the result is the user trying different steps and paths, which leads to a waste of time and effort and further leading to bad user reviews and frustration. In contrast, in one embodiment system 10 instead displays error messages that guide the user on what to do to avoid getting that error message. FIG. 8 illustrates automatically generated error messages, such as messages 801, 802, in accordance to embodiments.

### Example Cloud Infrastructure

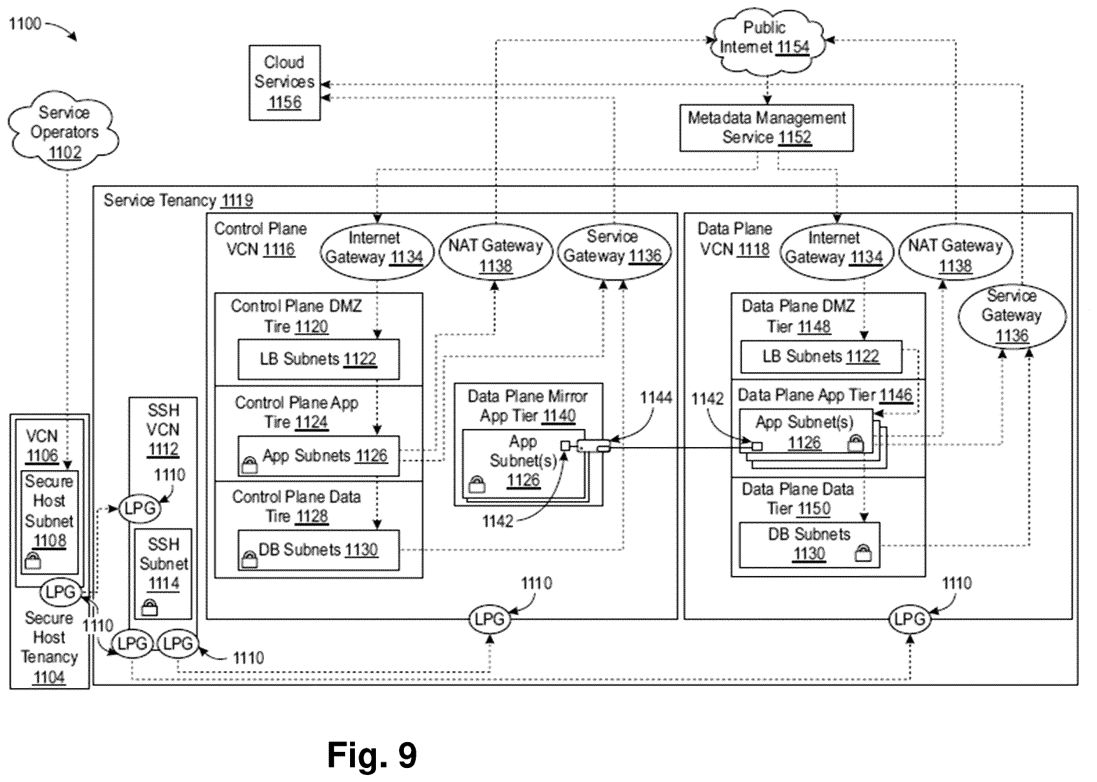

FIGS. 9-12 illustrate an example cloud infrastructure that can implement system 100 that can include UI customizer system 10 of FIG. 1 in accordance to embodiments. The use of the cloud infrastructure, as opposed to an on-premise implementation, allows for training data 308 to be receive from many different users that are interacting with the application of interest, which enhances the accuracy of ML model 306.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS” s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Meta Quest® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

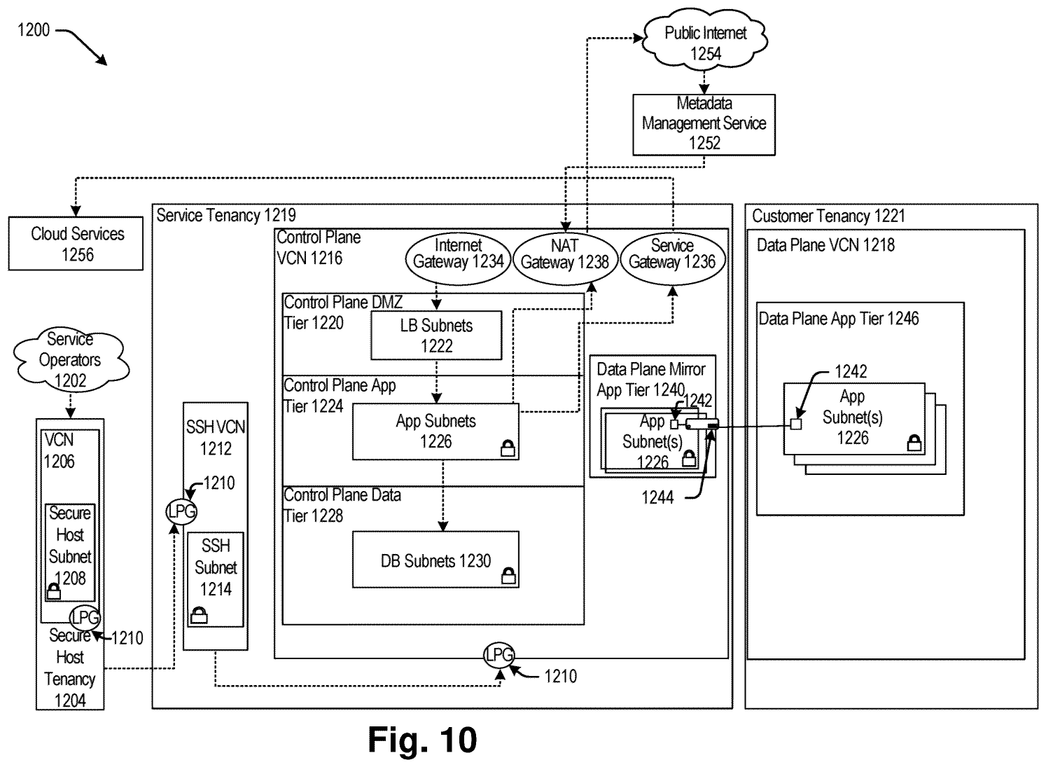

FIG. 10 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

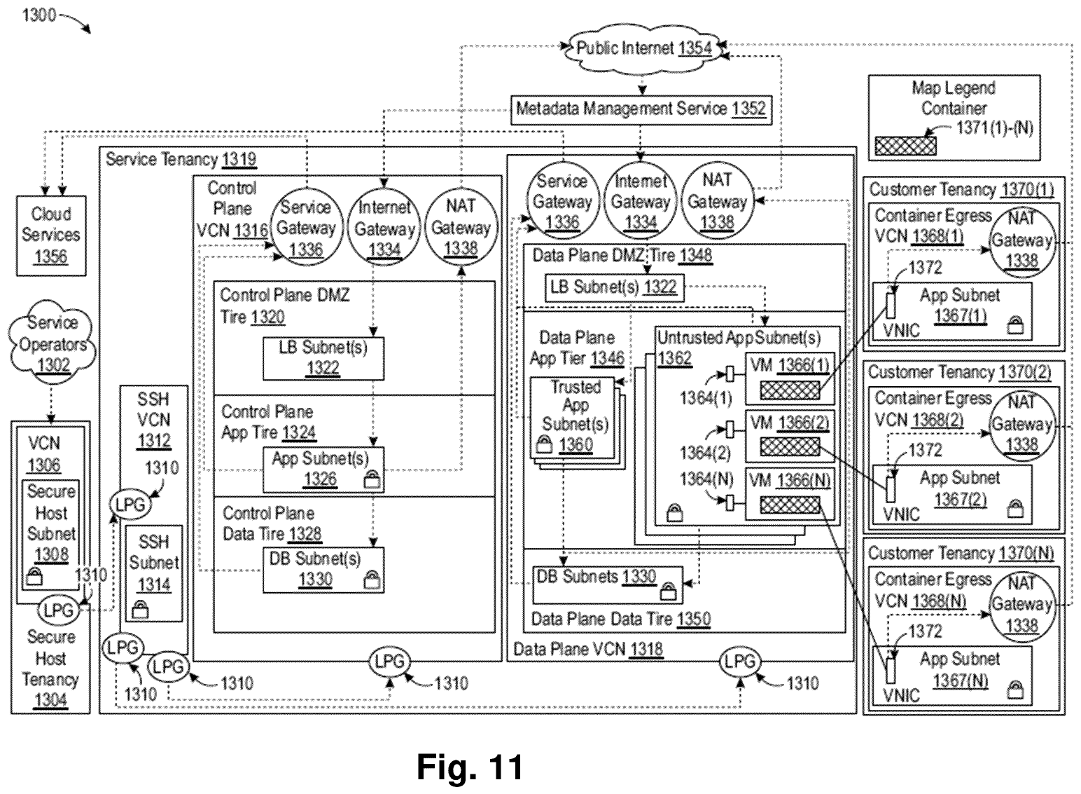

FIG. 11 is a block diagram 1300 illustrating another example pattern of an IaaS architecture, according to at least one embodiment. Service operators 1302 (e.g. service operators 1102) can be communicatively coupled to a secure host tenancy 1304 (e.g., the secure host tenancy 1104) that can include a virtual cloud network (VCN) 1306 (e.g., the VCN 1106) and a secure host subnet 1308 (e.g., the secure host subnet 1108). The VCN 1306 can include an LPG 1310 (e.g., the LPG 1110) that can be communicatively coupled to an SSH VCN 1312 (e.g., the SSH VCN 1112) via an LPG 1310 contained in the SSH VCN 1312. The SSH VCN 1312 can include an SSH subnet 1314 (e.g., the SSH subnet 1114), and the SSH VCN 1312 can be communicatively coupled to a control plane VCN 1316 (e.g., the control plane VCN 1116) via an LPG 1310 contained in the control plane VCN 1316 and to a data plane VCN 1318 (e.g., the data plane 1118) via an LPG 1310 contained in the data plane VCN 1318. The control plane VCN 1316 and the data plane VCN 1318 can be contained in a service tenancy 1319 (e.g., the service tenancy 1119).

The control plane VCN 1316 can include a control plane DMZ tier 1320 (e.g. the control plane DMZ tier 1120) that can include load balancer (“LB”) subnet(s) 1322 (e.g., LB subnet(s) 1122), a control plane app tier 1324 (e.g., the control plane app tier 1124) that can include app subnet(s) 1326 (e.g., similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g., the service gateway) and a network address translation (NAT) gateway 1338 (e.g., the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g., the data plane DMZ tier 1148), and a data plane data tier 1350 (e.g., the data plane data tier 1150 of FIG. 10). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

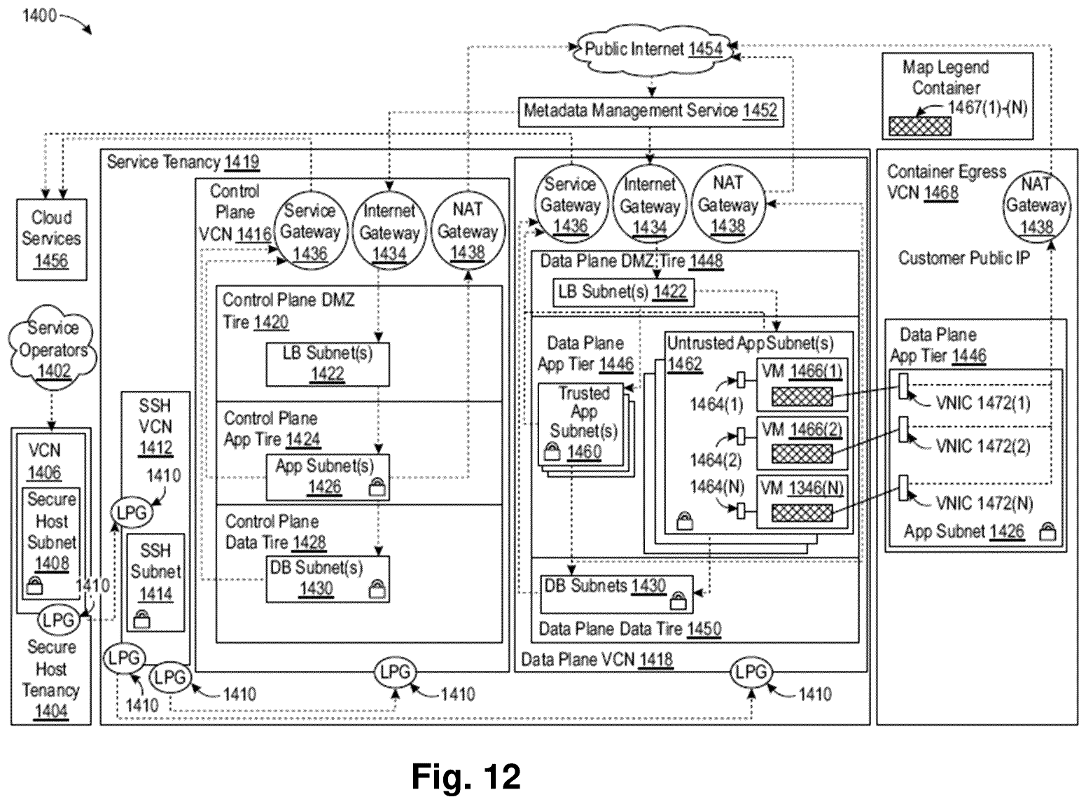

FIG. 12 is a block diagram 1400 illustrating another example pattern of an IaaS architecture, according to at least one embodiment. Service operators 1402 (e.g., service operators 1102) can be communicatively coupled to a secure host tenancy 1404 (e.g., the secure host tenancy 1104) that can include a virtual cloud network (“VCN”) 1406 (e.g., the VCN 1106) and a secure host subnet 1408 (e.g. the secure host subnet 1108). The VCN 1406 can include an LPG 1410 (e.g., the LPG 1110) that can be communicatively coupled to an SSH VCN 1412 (e.g., the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g., the control plane VCN 1116) via an LPG 1410 contained in the control plane VCN 1416 and to a data plane VCN 1418 (e.g., the data plane 1118) via an LPG 1410 contained in the data plane VCN 1418. The control plane VCN 1416 and the data plane VCN 1418 can be contained in a service tenancy 1419 (e.g., the service tenancy 1119).

The control plane VCN 1416 can include a control plane DMZ tier 1420 (e.g., the control plane DMZ tier 1120) that can include LB subnet(s) 1422 (e.g. LB subnet(s) 1122), a control plane app tier 1424 (e.g., the control plane app tier 1124) that can include app subnet(s) 1426 (e.g. app subnet(s) 1126), a control plane data tier 1428 (e.g. the control plane data tier 1128) that can include DB subnet(s) 1430 (e.g., DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway of FIG. 10) and a network address translation (NAT) gateway 1438 (e.g. the NAT gateway 1138 of FIG. 10). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 may be considered an exception to the pattern illustrated by the architecture of block diagram 1300 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments provide a ML based tool that can be used with any software. Embodiments analyze certain cues when the user starts using the software, and based on the cues, changes elements of the software's UI to suit the particular user. This happens automatically without human intervention, thus ensuring a seamless and comfortable user experience. Embodiments enhance the usability of any user-facing software

In contrast with known solutions that merely remove unused/rarely used widgets/UI elements, and place frequently used widgets in easily accessible locations, embodiments change elements in the software to provide a smoother experience to users depending on various behavioral cues gathered from users. Further, in contrast with known solutions that note the most frequently used features in applications and customize the UI for the user so they get access to these frequently used features, embodiments evaluate multiple cues from the user behavior to customize application for every user, where each user can have a different UI.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of optimizing a user interface (UI) of an application for a user, the method comprising:
training a machine learning (ML) model on one or more optimized routes for navigating the UI to arrive at a desired result;
monitoring at least a portion of a first navigation route during a user interaction with the UI to achieve the desired result;
determining by the ML model that the first navigation route is not the one or more optimized routes; and
redirecting the user to one of the optimized routes during the user interaction.

2. The method of claim 1, the redirecting comprising generating indicators on the UI that point to the redirected optimized route.

3. The method of claim 1, further comprising:
monitoring whether the user is switching between different applications during a predetermined period of time;
when the user is switching between different applications, providing an option to skip non-mandatory sections of the application or automatically displaying definitions of terminology during the user interaction.

4. The method of claim 1, further comprising:
monitoring a time between successive selections during the user interaction;
when the time exceeds a predetermined duration, automatically provide explanations in connection with a current selection item.

5. The method of claim 1, further comprising:
monitoring a number of times that the user attempts different routes of items on the UI before arriving at the desired result;
when the number of times exceeds a predefined amount, changing an order of the items.

6. The method of claim 1, further comprising:
monitoring an amount of time for the user to arrive the desired result;
when the amount of time exceeds a predefined amount, determining items that are not relevant to the user and hiding the determined items.

7. The method of claim 1, further comprising:
monitoring an amount of time and frequency that the user accesses help information;
when the amount of time exceeds a predefined amount, automatically providing explanations of terminology on the UI.

8. The method of claim 1, further comprising:
monitoring a speed of usage in a first color region of a plurality of different color regions;
when the speed of usage has slowed in comparison to other color regions, automatically adjusting a contrast in the first color region.

9. A computer readable medium having instructions stored thereon that, when executed by one or more processors, cause the processors to optimize a user interface (UI) of an application for a user, the optimizing comprising:
training a machine learning (ML) model on one or more optimized routes for navigating the UI to arrive at a desired result;
monitoring at least a portion of a first navigation route during a user interaction with the UI to achieve the desired result;
determining by the ML model that the first navigation route is not the one or more optimized routes; and
redirecting the user to one of the optimized routes during the user interaction.

10. The computer readable medium of claim 9, the redirecting comprising generating indicators on the UI that point to the redirected optimized route.

11. The computer readable medium of claim 9, the optimizing further comprising:
monitoring whether the user is switching between different applications during a predetermined period of time;
when the user is switching between different applications, providing an option to skip non-mandatory sections of the application or automatically displaying definitions of terminology during the user interaction.

12. The computer readable medium of claim 9, the optimizing further comprising:
monitoring a time between successive selections during the user interaction;
when the time exceeds a predetermined duration, automatically provide explanations in connection with a current selection item.

13. The computer readable medium of claim 9, the optimizing further comprising:
monitoring a number of times that the user attempts different routes of items on the UI before arriving at the desired result;
when the number of times exceeds a predefined amount, changing an order of the items.

14. The computer readable medium of claim 9, the optimizing further comprising:
monitoring an amount of time for the user to arrive the desired result;
when the amount of time exceeds a predefined amount, determining items that are not relevant to the user and hiding the determined items.

15. The computer readable medium of claim 9, the optimizing further comprising:
monitoring an amount of time and frequency that the user accesses help information;
when the amount of time exceeds a predefined amount, automatically providing explanations of terminology on the UI.

16. The computer readable medium of claim 9, the optimizing further comprising:
monitoring a speed of usage in a first color region of a plurality of different color regions;
when the speed of usage has slowed in comparison to other color regions, automatically adjusting a contrast in the first color region.

17. A cloud infrastructure system for optimizing a user interface (UI) of an application for a cloud user, the infrastructure system comprising:
a trained a machine learning (ML) model, the ML model trained on one or more optimized routes for navigating the UI to arrive at a desired result; and
one or more processors configured to:
monitor at least a portion of a first navigation route during a user interaction with the UI to achieve the desired result;
determine by the ML model that the first navigation route is not the one or more optimized routes; and
redirect the user to one of the optimized routes during the user interaction.

18. The cloud infrastructure system of claim 17, the redirecting comprising generating indicators on the UI that point to the redirected optimized route.

19. The cloud infrastructure system of claim 17, the processors further configured to:
monitor whether the user is switching between different applications during a predetermined period of time;
when the user is switching between different applications, provide an option to skip non-mandatory sections of the application or automatically display definitions of terminology during the user interaction.

20. The cloud infrastructure system of claim 17, the processors further configured to:
monitor a time between successive selections during the user interaction;
when the time exceeds a predetermined duration, automatically provide explanations in connection with a current selection item.
